(19) United States
(12) Patent Application Publication
(10) Pub. No.: US 2003/0028583 A1
(43) Pub. Date: Feb. 6, 2003

(54) Method and apparatus for providing dynamic workload transition during workload simulation on e-business application server

(75) Inventors: Romelia Flores, Keller, TX (US); Leonard S. Hand, Red Creek, NY (US); Philip E. Reed, Arlington, TX (US)

Correspondence Address: Gregory A. Nelson, Akerman Senterfitt, 222 Lakeview Avenue, Fourth Floor, P.O. Box 3188, West Palm Beach, FL, 33402-3188, US

(73) Assignee: International Business Machines Corporation, Armonk, NY

(21) Appl. No.: 09/919,439

(22) Filed: Jul. 31, 2001

(51) Int. Cl. G06F 9/00

(52) U.S. Cl. 709/105

(57) ABSTRACT

The present invention provides a method and system for providing dynamic workload transition. A servlet can be configured as a core (main) workload driver that dynamically monitors certain system parameters to determine the current state of the system. A servlet is a Java program that can extend the functionality of a Web server, generating dynamic content and interacting with web clients using a request-response paradigm. Here, the web clients can include external applications each of which can issue hypertext transfer protocol (HTTP) requests for workload processing. Based on the monitored system parameters, the servlet can dynamically determine whether a particular workload should be processed or whether a lighter workload should be processed in order to prevent further system overload. Upon determining that the current workload being processed is causing an overload condition, the servlet can reallocate system resources, for example by diminishing processing of the current workload and transition to a lighter workload that will lighten the load on the system. This transition to a lightened load will not add additional load to the overload condition, thereby causing the system performance to return to optimal operation.

### BACKGROUND OF THE INVENTION

1. Technical Field

The present invention relates to the field of e-business, and more particularly, to a method and apparatus for providing dynamic workload transition during workload simulation on an e-business application server.

2. Description of the Related Art

The pervasiveness of the Internet has allowed companies to exploit electronic communications to engage in what is commonly known as e-business activities with their customers. E-business involves conducting business on the Internet and not only includes buying and selling goods and services, but also includes servicing customers and collaborating with trading or business partners. To accommodate this vast range of activities, companies engaging in e-business have to ensure that their systems operate optimally by implementing a traffic flow management policy.

A traffic flow management policy is a set of rules which dictate how workloads should be handled by a system and its subsystems. A workload is a task or group of tasks that require system resources for processing. A work request can be used to initiate processing of a workload. An effective traffic flow management policy must assign and distribute tasks associated with a workload to various processing elements within the system and its subsystems. Moreover, to ensure optimal performance, the traffic flow management policy must constantly monitor system conditions and dynamically adjust the workload accordingly. Dynamic adjustment can include redistributing and rescheduling the tasks associated with a workload for processing.

E-business systems present a unique set of challenges to providing an effective traffic flow management policy. In e-business systems, legitimate overload conditions occur frequently and are generally unpredictable. A legitimate overload condition may result from several load factors which can include an increase in user demand, a partial website outage, and even the elimination of previous bottlenecks. For example, an increased user demand can occur when there are special events, promotions, and marketing campaigns facilitated by the website. Furthermore, when overload occurs, system performance is significantly degraded and this results in diminished capacity. From an economic perspective, the diminished capacity results in lost opportunity which translates directly to lost revenue.

Given the unique challenges presented by e-business systems, what is needed is an efficient method and system for applying resource management policies to transition different workloads in order to provide a robust e-business optimally operating system.

### SUMMARY OF THE INVENTION

The invention provides a method and system for dynamic workload transition in an application server for an e-business system. The method can include the steps of detecting an overload condition in the e-business system and executing a lighter workload upon detecting the system overload condition. Executing a lighter workload reduces system resources and prevents overload. Whenever adequate system resources become available, a request for the original workload or any new workload can be processed as normal. The step of detecting an overload condition can include monitoring system parameters, such as CPU utilization, disk I/O and memory utilization in the e-business system. The system parameters can be monitored to determine when an overload condition occurs in the e-business system.

In another aspect of the invention, the method can include the steps of diminishing the processing load of a first workload that causes a system overload condition and transitioning to a second lighter workload. Since the second lighter workload consumes less system resources than the first workload, it will add to the system overload condition. Subsequent requests that are made for the original workload will result in the processing of the second lighter workload until the system status indicates that the system is not overloaded. Once the system status returns to a normal condition where the overload condition does not exist, requests for the original workload will result in the first workload being processed. The method can further include the step of analyzing system parameters to determine causes for the system overload condition. The system parameters can include, but are not limited to, CPU utilization, disk I/O, memory utilization, and page ins. The method can also include the step of reporting the system parameters to a workload driver.

The invention also provides a method for dynamic workload transition in an application server for an e-business system. The method can include processing a workload assigned to a workload driver. The e-business system can be monitored to detect when overload conditions occur. Based on the results of the monitoring, a lighter workload can be processed whenever the workload driver detects a system overload condition caused by the processed workload. Upon a request to process the original workload and available adequate processing resources, the workload driver can transition to the originally processed workload.

A system for providing dynamic workload transition in an e-business system is also disclosed. The system can include an application server for processing work requests and for processing workloads identified by the work requests. A workload driver can be utilized for handling workload management of the application server. The handling can include reducing processing resources necessary for processing a currently processed workload when an overload condition exists by initiating the processing of a workload which has a lighter load and requires less system resources. A status driver can report system data to the workload driver, and the reported system data can provide information necessary for determining the existence of the overload condition.

### BRIEF DESCRIPTION OF THE DRAWINGS

There are presently shown in the drawings embodiments which are presently preferred, it being understood, however, that the invention is not limited to the precise arrangements and instrumentalities shown, wherein:

FIG. 1 is a high level block diagram of an exemplary system for providing dynamic workload control and transition; and

FIG. 2 shows exemplary XML formatted workloads having varying loads.

### DETAILED DESCRIPTION OF THE INVENTION

The present invention provides a method and system for dynamic workload transition. Dynamic workload transition includes switching between workloads having varying load requirements in order to ensure that an e-business system can perform optimally under different load conditions. In accordance with the invention, a servlet can be configured as a core (main) workload driver that dynamically monitors certain system parameters that are indicative of the current state of the system. A servlet can be a Java program that extends the functionality of a Web server, generating dynamic content and interacting with web clients using a request-response paradigm. In this case, the web clients can be simulated by a user driver which issues hypertext transfer protocol (HTTP) requests to the core workload driver for processing. Based on the monitored system parameters, the servlet can dynamically determine when a system overload condition and/or performance degradation is occurring.

Upon determining the existence of an overload condition, the servlet can diminish processing of the current workload by trainsitioning to lighter workload. This transition to a lightened load will not contribute to the system overload conditions and therefore can provide assistance in having the system return to an optimal operating state. Diminishing a workload means that the resources currently allocated to a workload is decreased. As an illustration of the diminishing of resources, the available resources dedicated to WRKLD_{—}005 can be diminished from 35% to 10% and the resources dedicated to workload WRKLD_{—}001 can be increased from 65% to 90%.

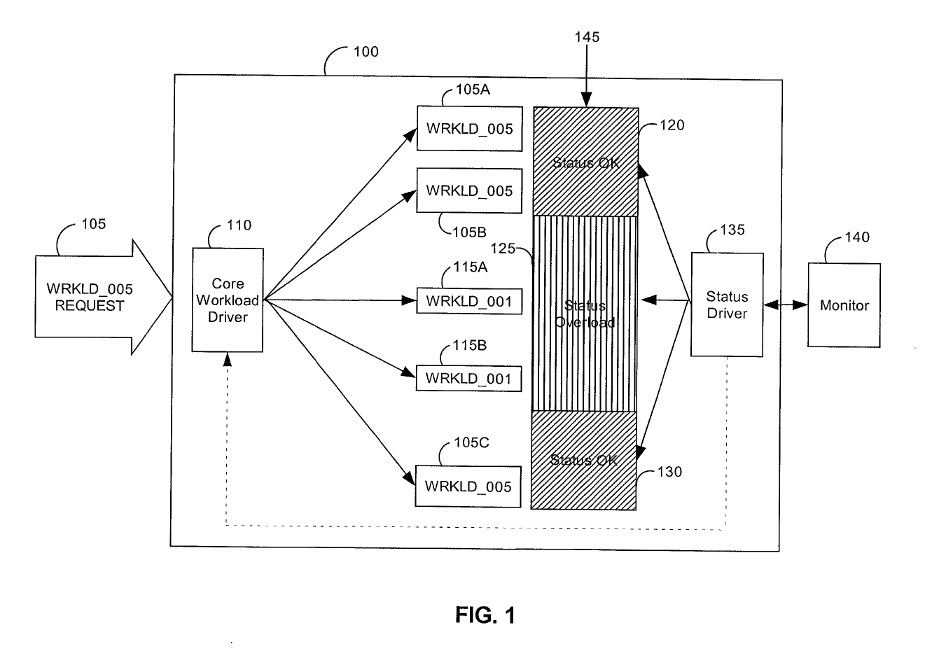

FIG. 1 is a high level block diagram of an exemplary system for providing dynamic workload control and transition. Referring to FIG. 1, there is shown an application server 100, a core workload driver 110, a status driver 135, a monitor 140, and status indicator 145.

Application server 100 is a platform that can deliver application services to servers, databases, clients, applications, servlets and devices, which can be used to process e-business related transactions. Application servers are known in the art and depending on the vendor, can provide additional enhanced services to support specific vendee requirements. For example, some application servers can contain built in traffic flow management which can include traffic monitoring and control functions.

The core workload driver 110 can be a servlet which can be instantiated by the application server 100, and which can be configured to receive workload requests. The request can be initiated by a user driver. For example, core workload driver can be configured to receive and process workload requests such as WRKLD_{—}005 105. The core workload driver 110 runs on the application server 100. The core workload driver 110 contains software logic that will ultimately execute the commands defined for the workload to be executed.

Status driver 135 can be a servlet which can be instantiated by the application server 100, and collects and reports information related to the overall system performance. The system information can be collected from monitor 140. Monitor 140 can be a system management application or tool that can be used to collect system information. System management applications or tools are well known in the art and typically utilize agents to collect and report system information.

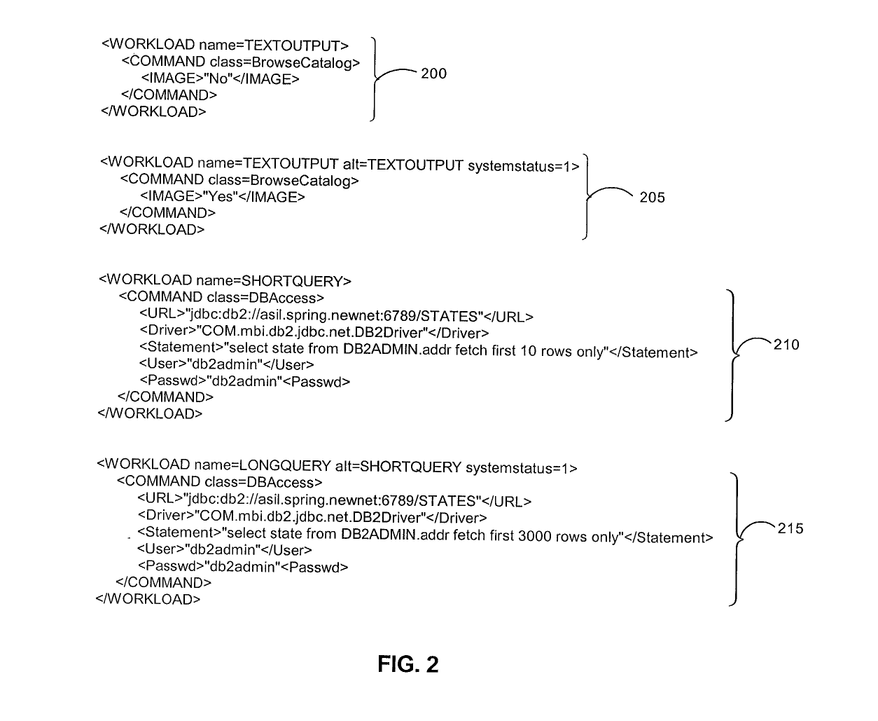

FIG. 2 shows exemplary XML formatted workloads having varying loads requirements. Referring to FIG. 2, exemplary workload definitions 200, 205, 210, 215 are shown. A workload definition contains the commands that define the tasks that are to be executed for a workload. Workload definitions 200, 205, 210, 215 can be defined in a configuration file that can be accessed by the core workload driver 110. Although the workload definitions illustrated in FIG. 2 utilize XML formatting, it should readily be understood by one skilled in the art that the use of XML formatted workload definitions in a configuration file is not intended to be a limitation on the system. Accordingly, other communication formats similar to XML and/or plain text, can be utilized to define the workloads.

The workload definitions 200, 205, 210, 215 have varying load requirements since the computing resources necessary for processing the commands for the tasks defined in the respective workloads vary in degree. Referring to FIG. 2, XML formatted workload definition (TEXTOUTPUT) 200 defines a workload which can provide text results to a user. XML formatted workload definition (IMAGEOUTPUT) 205 defines a workload that can provide image results to a user. The workload defined by workload definition 205 requires more data and multiple interactions with the application server 100, than is required by workload defined by the workload definition 200. This is mostly due to the fact that the workload defined by workload definition 205 has commands that require image processing which utilizes more computing resources than is required for processing the text defined by the commands of workload definition 205. Consequently, the computing resources necessary for processing the workload defined by workload definition 205 is greater than the computing resources necessary for processing the workload defined by workload definition 200. The load on the system due to the commands in workload 205 is, therefore, greater than the load due to the commands on workload 200.

Workload 210 can be used to execute a query (SHORTQUERY) which permits fetching up to 10 rows of data. Workload 215 can be used to execute a query (LONGQUERY) which can permit up to 3000 rows of data to be returned. As a result, workload 215 requires significantly more computing resources than workload 210, since workload 215 permits up to 3000 rows of data to be fetched.

Based on the workload definitions, the core driver 110 can assess overall system load and accordingly determine which workload should be processed. Subsequent to receiving a workload request, for example WRKLD_{—}005 105, the core workload driver 110 will attempt to execute the command(s) defined by the workload. The core workload driver 110 contains software logic that will ultimately execute the commands defined for the workload being executed. Factors including the priority of the requesting user, the current load on the system due to other commands being executed and the amount of processing resources that will be required for any requesting and new workloads will be considered by the core workload driver 110. Monitor 140 can monitor factors such as the system load. Monitored data related to the system load can be collected by the status driver 135 and reported to the core workload driver 110. The monitored data relating to the system load can include, but is not limited to, parameters such as CPU utilization, memory usage, page Ins, disk I/O and run queue. These parameters can either be passed to the core workload driver 110 by the status monitor 135 or made accessible to the core workload driver 110.

The software logic contained in the core workload driver 110 can assess the data from the status driver 135, along with other data related to the factors previously described, and will determine whether it is appropriate to transition from one workload to another. For example, if the status driver 135 reports that the system is 75% utilized, and a request from a user includes a database query requiring 1 million rows of data, the core workload driver 110 will make a determination that the request cannot be immediately executed. Consequently, the software logic can transition the workload request and perform alternate lighter workloads which require less processing resources. In this case, the software logic in the core workload driver 110 could make a determination that the first 100,000 rows of data could be obtained and sent. The core workload driver 110 could subsequently send a message to the requestor, requiring the requester to make a subsequent request to acquire the remainder of the requested data. In another aspect of the invention, a new request can be made in order to process the original 1 million rows.

As an illustration and with reference to FIG. 1, the status driver 135 can collect system data from monitor 140. The status driver can report the collected system data to the core workload driver 110. A status indicator 145 depicts the collected system data that signifies the system load. Status indicator 145 indicates that the system is approximately 65% utilized. The core workload driver 110 receives workload request 105 (WRKLD_{—}005). The core workload driver 110 determines that there is sufficient resources available to process two requests for WRKLD_{—}005 105A and 105B as indicated by section 120 of the status indicator 145. However, there is insufficient resources to process a subsequent request portion 105C of WRKLD_{—}005 as indicated by 125 of the status indicator 145. Consequently, the core workload driver 110 transitions any requests for WRKLD_{—}005 to lighter workloads (WRKLD_{—}001), as depicted by 115A and 115B. WRKLD_{—}001 can be a lighter workload or it can be a newly requested workload. By defining the workloads in a system so that they have varying workloads, it is possible to easily transition between heavier and lighter workloads whenever there is an overload condition.

Whenever the status driver 135 reports that there is sufficient processing resources available as illustrated by section 130 of the status indicator, the core workload driver 110 will process requests for WRKLD_{—}005 as depicted in 105C. It should be recognized that in transitioning to a lighter workload, the amount of resources being utilized are diminished. When the unavailability of system resources dictate that a transition be made to a lighter workload, the heavier workload can be processed as normal. Whenever adequate resources become available an unrelated new load can be processed.

The present invention can be realized in hardware, software, or a combination of hardware and software. A method and apparatus for providing dynamic workload transition according to the present invention can be realized in a centralized fashion in one computer system, or in a distributed fashion where different elements are spread across several interconnected computer systems. Any kind of computer system, or other apparatus adapted for carrying out the methods described herein, is suited. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

1. A method for providing dynamic workload transition in an application server for an e-business system, comprising:
detecting an overload condition in the e-business system;
reducing system resources allocated to a first set of workload tasks in the e-business system;
allocating at least part of said reduced system resources to a second set of lighter workload tasks in the e-business system; and
if adequate resources in the e-business system become available and if said first set of workload tasks require processing, allocating said adequate resources to said first set of workload tasks.

2. The method according to claim 1, wherein said detecting step further comprises
monitoring system parameters in the e-business system; and
analyzing said monitored system parameters to determine when said overload condition occurs in the e-business system.

3. The method according to claim 2, wherein said monitored system parameters comprises CPU utilization, disk I/O and memory utilization.

4. A method for providing dynamic workload transition in an application server for an e-business system, comprising:
receiving a first work request;
determining the workload of said first work request;
comparing said determined workload of said first work request to available system resources to determine if the performance of said first work request is capable of causing a system overload condition; and
if said workload of said first work request is capable of causing a system overload condition, transitioning to a second lighter work request, said second lighter work request having a lighter workload requiring less system resources, thereby preventing said system overload condition.

5. The method according to claim 4, further comprising analyzing system parameters to determine whether said first workload causes said system overload condition.

6. The method according to claim 5, wherein said system parameters comprises CPU utilization, disk I/O and memory utilization.

7. The method according to claim 5, further comprising, reporting said system parameters to a workload driver.

8. A method for providing dynamic workload transition in an application server for an e-business system, comprising:
processing a workload assigned to a workload driver;
monitoring system resources to detect an overload condition while processing said workload;
allocating processing resources to a lighter workload when said workload driver detects a system overload condition caused by said processed workload during said monitoring step; and
if said processed workload still require processing, transitioning to said processed workload from said lighter workload upon availability of adequate processing resources.

9. A system for providing dynamic workload transition in an e-business system, comprising:
an application server for receiving work requests and for processing workloads identified by said work requests;
a workload driver for handling workload management of said application server, said handling comprising diminishing processing of a currently processed workload which causes an overload condition, and initiating the processing of a lighter workload, said lighter workload having a lighter load than said diminished workload; and
a status driver for reporting system data to said workload driver, said system data providing information regarding the existence of said overload condition.

10. A machine readable storage having stored thereon, a computer program having a plurality of code sections, said code sections executable by a machine for causing the machine to perform the steps of:
detecting an overload condition in an e-business system, said detecting step for providing dynamic workload transition in an application server for the e-business system;
reducing system resources allocated to a first set of workload tasks in the e-business system;
allocating at least part of said reduced e-business system resources to a second set of lighter workload tasks in the system; and
if adequate resources in the e-business system become available and if said first set of workload tasks still require processing, allocating said adequate resources to said first set of workload tasks.

11. The machine readable storage according to claim 10, wherein said detecting step further comprises:
monitoring system parameters within the e-business system; and
analyzing said monitored system parameters to determine when said overload condition occurs in the e-business system.

12. The machine readable storage according to claim 11, wherein said monitored system parameters comprises CPU utilization, disk I/O and memory utilization.

13. A machine readable storage having stored thereon, a computer program having a plurality of code sections, said code sections executable by a machine for causing the machine to perform the steps of:
receiving a first work request, said receiving step for providing dynamic workload transition in an application server for an e-business system;
determining a workload of said first work request;
comparing said determined workload of said first work request to available system resources to determine if the performance of said first work request is capable of causing a system overload condition; and
if said workload of said first work request is capable of causing a system overload condition, transitioning to a second lighter work request, said second lighter work request having a lighter workload requiring less system resources, thereby preventing said system overload condition.

14. The machine readable storage according to claim 13, further comprising analyzing system parameters to determine whether said first workload causes said system overload condition.

15. The machine readable storage according to claim 14, wherein said system parameters comprises CPU utilization, disk I/O and memory utilization.

16. The machine readable storage according to claim 14, further comprising, reporting said system parameters to a workload driver.

17. A machine readable storage having stored thereon, a computer program having a plurality of code sections, said code sections executable by a machine for causing the machine to perform the steps of:
processing a workload assigned to a workload driver, said processing for providing a dynamic workload transition in an e-business system;
monitoring system resources to detect an overload condition while processing said workload;
allocating processing resources to a lighter workload when said workload driver detects a system overload condition caused by said processed workload during said monitoring step; and
if said processed workload still require processing, transitioning to said processed workload from said lighter workload upon availability of adequate processing resources.
